(19) United States
(12) Patent Application Publication
(10) Pub. No.: US 2010/0270939 A1
(43) Pub. Date: Oct. 28, 2010

(54) Method And Electronic Ballast for Operating a High Pressure Discharge Lamp

(75) Inventors: Stefan LICHTENBERG, Falkensee (DE); Joachim MÜHLSCHLEGEL, Grobenzell (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschrankter Haftung, Munich (DE)

(21) Appl. No.: 12/769,416

(22) Filed: Apr. 28, 2010

(30) Foreign Application Priority Data
Apr. 28, 2009 (DE) 10 2009 019 156.9

(51) Int. Cl. H05B 41/24

(52) U.S. Cl. 315/246

(57) ABSTRACT

A method for operating a high pressure discharge lamp with the aid of a high frequency signal is disclosed. The high pressure discharge lamp comprises at least one first (14a) and one second electrode (14b), the first (14a) and the second electrodes (14b) being arranged in such a way that the electrode tips (18a, 18b) are situated opposite one another, a filament (16a, 16b) respectively being arranged in the region of the electrode tips (18a, 18b). The high pressure discharge lamp runs through the following phases in a start phase before its stationary operation: a delay phase, a breakdown phase, an electrode heating phase and a burner heating phase. After termination of the electrode heating phase, the first (14a) and the second electrodes (14b) are driven within at least one prescribable time duration in such a way that the high pressure discharge lamp is operated with the aid of a lamp current (I_{boost}) that is higher than the rated lamp current (Iₙₑₙₙ). The high pressure discharge lamp is operated in such a way that within the at least one prescribable time duration it has an instantaneous lamp operating voltage (U_{Bmom}) that is at least 40% of the rated lamp operating voltage (U_{Bnenn}) in the stationary operation. A corresponding electronic ballast for operating a high pressure discharge lamp is also disclosed.

### RELATED APPLICATION

This application claims the priority of German application no. 10 2009 019 156.9 filed Apr. 28, 2009, entire content of which is hereby incorporated by reference.

### FIELD OF THE INVENTION

The present invention relates to a method for operating a high pressure discharge lamp with the aid of a high frequency signal, and to an electronic ballast for operating such a lamp.

### BACKGROUND OF THE INVENTION

A high pressure discharge lamp comprises at least one first and one second electrode, the first and the second electrode being arranged in such a way that the electrode tips are situated opposite one another, and a filament being arranged in the region of the electrode tips. The high pressure discharge lamp runs through the following phases in a start phase before its stationary operation: a delay phase, a breakdown phase, an electrode heating phase and a burner heating phase. After termination of the electrode heating phase, the first and the second electrodes are driven within at least one prescribable time duration in such a way that the high pressure discharge lamp is operated with the aid of a lamp current that is higher than the rated lamp current. An electronic ballast for operating a high pressure discharge lamp with the aid of a high frequency signal comprises a control apparatus that is designed to operate the high pressure discharge lamp in the following phases in a start phase before its stationary operation: a delay phase, a breakdown phase, an electrode heating phase and a burner heating phase. The control apparatus is further designed to operate the high pressure discharge lamp after termination of the electrode heating phase with a lamp current that is higher than the rated lamp current.

During high frequency operation of high pressure discharge lamps, arc attachment on the filament of the electrodes or even behind the filament has been observed. However, it is desired for the arc to run from electrode tip to electrode tip. The result of the attachment of the arc to an undesired site is that the electrodes wear too quickly such that the service life of the high pressure discharge lamp is significantly reduced.

If a high pressure discharge lamp is operated with the aid of a low frequency signal, the problem of the undesired attachment of the arc to the filament of the electrodes does not occur. The reason for this is that in the case of low frequency operation, the time duration in which current flows from one electrode to the other is long enough to heat up the appropriate electrode throughout. The arc is therefore drawn onto the electrode tip, as desired.

However, low frequency operation has the disadvantage that it is more complicated to implement and the corresponding electronic ballast exhibits undesirably high losses.

US 2003/0127993 discloses a generic method for operating a high pressure discharge lamp. In accordance with the teaching of said publication, the high pressure discharge lamp is operated with the aid of a high frequency signal, a lamp current that makes up at least 85% of the maximum current being impressed on the high pressure discharge lamp during the entire time duration of the burner heating phase (arc tube heating) in order to avoid arc attachment on the filament, called back-arcing there. As may be gathered from FIG. 3 of said publication, at the start of this burner heating phase the lamp operating voltage is approximately 10 to 20% of the rated lamp operating voltage in the stationary operation, that is to say the typical operating voltage specified in the lamp data sheet, and is approximately 100% of the rated lamp operating voltage in the stationary operation. Proceeding in accordance with this teaching, two disadvantages are established: firstly, the lamp bulb is blackened from within, with the result that less light can be emitted, and secondly material is removed or material is vapor-deposited on the lamp electrodes, and this leads to a shortening of the lamp service life.

### SUMMARY OF THE INVENTION

One object of the present invention is therefore to develop the method mentioned at the beginning, and/or the electronic ballast mentioned at the beginning in such a way that, on the one hand, attachment of the arc on or behind at least one of the filaments can be prevented reliably, however on the other hand no blackening of the lamp bulb occurs.

The present invention takes advantage of the finding that the blackening of the lamp bulb is caused by the fact that in the prior art the high current phase, that is to say the phase of operation of the high pressure discharge lamp with the aid of a lamp current that is higher than the rated lamp current, is implemented at a point in time when the internal pressure of the high pressure discharge lamp is still too low. The internal pressure of the high pressure discharge lamp is correlated with the instantaneous lamp operating voltage. With reference to FIG. 3 of US 2003/0127993 A1, it is therefore wrong to operate the high pressure discharge lamp right at the beginning of the burner heating phase with the aid of a lamp current that is higher than the rated lamp current. At this instant, the lamp operating voltage is still too low, approximately 10 to 20% of the rated lamp operating voltage in the stationary operation, the result being that the internal lamp pressure is not high enough to prevent evaporation of tungsten from the electrodes. This then leads to the undesired effects of a blackening of the lamp bulb, and of a melting down of the electrodes.

If the high current phase is now introduced at a point in time when a substantial portion of the fill, in particular mercury and MH fill, has already been evaporated, the high pressure in the lamp acts as a diffusion barrier such that tungsten evaporated or sputtered off from the electrode cannot be deposited on the wall. This is the case when the high current phase is executed at points in time when the instantaneous lamp operating voltage is at least 40% of the rated lamp operating voltage in the stationary operation.

In a preferred development, the prescribable time duration is 0.1 to 30 s, in particular 0.1 to 5 s, when the instantaneous lamp operating voltage is greater than 60% of the rated lamp operating voltage, and, in particular 0.2 to 30 s when the instantaneous lamp operating voltage is between 40 and 60% of the rated lamp operating voltage.

Although it is known from US 2003/0127993 A1 to position the high current phase in the burner heating phase, this being disadvantageously throughout the entire burner heating phase however, it can be provided according to the invention to permit the high current phase to take place—in accordance with the criteria of the invention—during the burner heating phase or even, more preferably, during the stationary operation of the high pressure discharge lamp. A change is obtained there in the moving of the attachment of the arc from the filament onto the electrode tip in conjunction with minimal current rise and/or shortest possible time duration. Owing to the fact that the high current need be made available only for a short time, the electronic ballast used to operate the high pressure discharge lamp is spared, likewise owing to the fact that even a small rise suffices, since at this point in time a substantial internal pressure has already been built up in the high pressure discharge lamp.

It preferably holds for the lamp current during the at least one prescribable time duration that: 1.2<=I_{boost}/Iₙₑₙₙ<=3.5, in particular 1.6<=I_{boost}/Iₙₑₙₙ<=2.5, I_{boost} representing the lamp current during the prescribable time duration, and Iₙₑₙₙ representing the rated lamp current. With reference to the above statements, it follows that, if the at least one prescribable time duration takes place during the stationary operation, the lamp current I_{boost} preferably moves on the lower bound of the specified current ranges.

In a particularly preferred development, after step a) a check is made as to whether the arc runs from the tip of the first electrode to the tip of the second electrode, step a) being repeated at least once if this is not the case. This opens up the possibility of attempting in a first experiment to change over the attachment of the arc from the filament to the electrode tip with the aid of operating parameters, that is to say, in particular, to choose the lamp current during the prescribable time duration, and the length of the time duration itself such that they produce the least possible loading of the electronic ballast and/or of the high pressure discharge lamp. If the desired goal has not been reached, step a) can be repeated, a changeover now being made to more heavily loading values of at least of one of the two parameters in order now to reach the goal with greater reliability.

In the event of a repetition of step a), the lamp current I_{boost} is preferably raised by comparison with the previous step a) by 0.1*I_{boost} to 1.0*I_{boost}. Furthermore, in the event of a repetition of step a), that is to say with the original lamp current I_{boost} or, with reference to the previous statements, even with a raised lamp current I_{boost}, it is preferred for the prescribable time duration to be raised by comparison with the previous step a) by 20% to 200%. The raising of the lamp current and/or the increase in the prescribable time duration can be performed in stepwise fashion, it being possible to raise the lamp current independently of the increase in the time duration, or at the same time.

The lamp operating voltage is preferably evaluated in order to determine whether the arc runs from the tip of the first electrode to the tip of the second electrode. If the instantaneously measured lamp operating voltage is between 5 and 10% above the expected lamp operating voltage, it is to be assumed that the arc does not yet run from the tip of the first electrode to the tip of the second electrode.

The preferred embodiments described with reference to the inventive method, and their advantages, hold correspondingly, to the extent that they can be applied, for the inventive electronic ballast. In this case, the control apparatus is designed to carry out the corresponding method steps.

### BRIEF DESCRIPTION OF THE DRAWINGS

An exemplary embodiment of an inventive method is now described in more detail below with reference to the attached drawings, in which:

FIG. 1 shows a schematic of the bulb of a high pressure discharge lamp in the case of which the arc attachment does not lie on the electrode tip in the case of the left-hand electrode; and

FIG. 2 is a schematic of the time profile of the instantaneous lamp operating voltage U_{Bmom}, plotted against time.

### DETAILED DESCRIPTION OF THE DRAWINGS

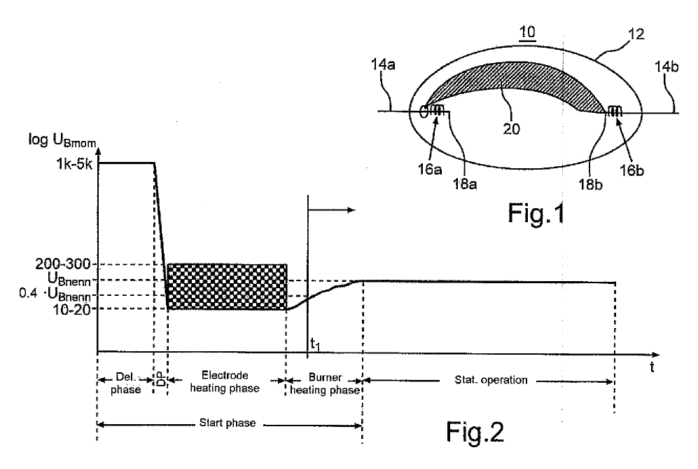

FIG. 1 shows the bulb 10 of a high pressure discharge lamp. The latter comprises a transparent glass housing 12 as well as a first 14a and second electrode 14b. A filament is arranged on the end of each electrode 14a, 14b, thus the filament 16a on the electrode 14a, and the filament 16b on the electrode 14b. The electrode tips are denoted by 18a and 18b.

Represented, furthermore, is an arc 20 that is bent upward as a consequence of convection. As is clearly evident, in the region of the left-hand electrode 14a the arc is attached not to the electrode tip 18a but behind the filament 16a. However, it is desired for the arc 20 to extend between electrode tip 18a and the electrode tip 18b.

FIG. 2 shows the time profile of the instantaneous operating voltage U_{Bmom}, the instantaneous operating voltage U_{Bmom} being plotted logarithmically in order to enable the relevant regions to be effectively detected. During a delay phase, the instantaneous lamp operating voltage U_{Bmom} is between 1 kV and 5 kV. This breaks down during a breakdown phase DP to values between 10 and 20 V. Following thereupon is an electrode heating phase in which the lamp operating voltage can rise up to 200 or even 300 V. As illustrated by the dotted voltage range in FIG. 2, during the overall electrode heating phase the instantaneous operating voltage U_{Bmom} can jump back and forth between 10 and 300 V.

Following the electrode heating phase is the burner heating phase. The start of the burner heating phase is defined by the fact that a stable arc 20 has been produced between the first 16a and the second electrode 16b. After the burner heating phase, the instantaneous lamp operating voltage U_{Bmom} rises from 10 to 20 V to the rated lamp operating voltage in the stationary operation, which corresponds to the typical operating voltage of the lamp specified in the lamp data sheet.

A region is plotted that begins at the instant t₁, this instant being characterized by the fact that there the instantaneous lamp operating voltage U_{Bmom} is 40% of the rated lamp operating voltage U_{Bnenn} in the stationary operation. As marked by the arrow relating to the instant t₁, the high pressure discharge lamp is able to be operated with a lamp current that is higher than the rated lamp current only starting from this instant, at least during a prescribable time duration. The end result of this measure is that, on the one hand, the arc 20 extends from the electrode tip 18a to the electrode tip 18b while, on the other hand, a blackening of the lamp bulb 10 and a meltdown of electrodes 14a, 14b are reliably prevented.

As is clearly to be seen from FIG. 2, the prescrible time duration can take place during the burner heating phase or during the stationary operation.

It holds for the lamp current in this phase that: 1.2<=I_{boost}/Iₙₑₙₙ<=3.5, in particular 1.6<=I _{boost}/Iₙₑₙₙ<=2.5, I_{boost} representing the lamp current during the prescribable time duration, and Iₙₑₙₙ representing the rated lamp current. The prescribable time duration is, in particular, 0.1 to 30 s, in particular 0.1 to 5 s when the instantaneous lamp operating voltage is higher than 60% of the rated lamp operating voltage, and in particular 0.2 to 30 s when the instantaneous lamp operating voltage is between 40 and 60% of the rated lamp operating voltage.

Should it happen that, after the first time application of a high current phase, the arc still does not extend from the electrode tip 18a to the electrode tip 18b, something which can be checked by evaluating the lamp operating voltage, one or more further high current phases can ensue. The lamp current I_{boost} and/or the prescribable time duration can be raised/increased within these further high current phases.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

We I claim:

1. A method for operating a high pressure discharge lamp with the aid of a high frequency signal, the high pressure discharge lamp comprising at least one first and one second electrode, the first and the second electrodes being arranged in such a way that the electrode tips are situated opposite one another, a filament respectively being arranged in the region of the electrode tips, the high pressure discharge lamp running through the following phases in a start phase before its stationary operation: a delay phase, a breakdown phase, an electrode heating phase and a burner heating phase, wherein the method comprises the steps of:
after termination of the electrode heating phase, driving the first and the second electrodes within at least one prescribable time duration in such a way that the high pressure discharge lamp is operated with the aid of a lamp current that is higher than the rated lamp current; and
operating the high pressure discharge lamp in such a way that within the at least one prescribable time duration the lamp has an instantaneous lamp operating voltage that is at least 40% of the rated lamp operating voltage in the stationary operation.

2. The method as claimed in claim 1, wherein the prescribable time duration is 0.1 to 30 s, when U_{Bmom}>0.6*U_{Bnenn}, wherein U_{Bmom} is the instantaneous lamp operating voltage and U_{Bnenn} being the rated lamp operating voltage, and 0.2 to 30 s, when 0.4*U_{Bnenn}<=U_{Bmom}<=0.6*U_{Bnenn}.

3. The method as claimed in claim 1, wherein the at least one prescribable time duration takes place during the burner heating phase.

4. The method as claimed in claim 1, wherein the at least one prescribable time duration takes place during the stationary operation.

5. The method as claimed in claim 1, wherein the lamp current during the at least one prescribable time duration follows the following relationship:
1.2<=I_{boost}/Iₙₑₙₙ<=3.5,
wherein I_{boost} represents the lamp current during the prescribable time duration, and Iₙₑₙₙ represents the rated lamp current.

6. The method as claimed in claim 1, wherein after the operating step a check is made as to whether the arc runs from the tip of the first electrode to the tip of the second electrode, the operating step being repeated at least once if this is not the case.

7. The method as claimed in claim 6, wherein in the event of a repetition of the operating step, the lamp current is raised by comparison with the previous operating step by 0.1*I_{boost} to 1.0*I _{boost}.

8. The method as claimed in claim 6, wherein in the event of a repetition of the operating step, the prescribable time duration is raised by comparison with the previous operating step by 20% to 200%.

9. The method as claimed in claim 6, wherein the lamp operating voltage is evaluated in order to determine whether the arc runs from the tip of the first electrode to the tip of the second electrode.

10. The method as claimed in claim 2, wherein the prescribable time duration is 0.1 to 5 s, when U_{Bmom} >0.6*U_{Bnenn}.

11. The method as claimed in claim 5, wherein the lamp current during the at least one prescribable time duration follows the following relationship:
1.6<=I_{boost}/Iₙₑₙₙ<=2.5,
wherein I_{boost} represents the lamp current during the prescribable time duration, and Iₙₑₙₙ represents the rated lamp current.

12. An electronic ballast for operating a high pressure discharge lamp with the aid of a high frequency signal, the electronic ballast comprising a control apparatus that is designed to operate the high pressure discharge lamp in the following phases in a start phase before its stationary operation: a delay phase, a breakdown phase, an electrode heating phase and a burner heating phase,
wherein the control apparatus is configured to operate the high pressure discharge lamp after termination of the electrode heating phase with a lamp current that is higher than the rated lamp current, and
wherein the control apparatus is configured to operate the high pressure discharge lamp in such a way that within the at least one prescribable time duration it has an instantaneous lamp operating voltage that is at least 40% of the rated lamp operating voltage in the stationary operation.
